(19) United States
(12) Patent Application Publication
(10) Pub. No.: US 2024/0103922 A1
(43) Pub. Date: Mar. 28, 2024

(54) DESIGN EXECUTION APPARATUS AND DESIGN EXECUTION METHOD

(71) Applicant: Hitachi, Ltd., Tokyo (JP)

(72) Inventors: Fumiya KUDO, Tokyo (JP); Masaya ITOH, Tokyo (JP); Takeshi SAITO, Tokyo (JP); Tsunamichi TSUKIDATE, Tokyo (JP)

(21) Appl. No.: 18/119,167

(22) Filed: Mar. 8, 2023

(30) Foreign Application Priority Data
Sep. 26, 2022 (JP) 2022-152212

(51) Int. Cl. G06F 9/50

(52) U.S. Cl. CPC G06F 9/5038; G06F 2209/5017

(57) ABSTRACT

A design execution apparatus includes: an input unit that inputs task group information indicating a task group including one or more tasks to be executed by an autonomous body and environmental information indicating an environment in which the task is executed; a determining unit that determines an order in which the autonomous body executes tasks included in a task group indicated by the task group information, based on the task group information and the environmental information that are input by the input unit; and a memory unit that stores order information indicating the order determined by the determining unit.

### CROSS-REFERENCE TO RELATED APPLICATION

This application claims priority pursuant to 35 U.S.C. § 119 from Japanese Patent Application No. 2022-152212, filed on Sep. 26, 2022, the entire disclosure of which is hereby incorporated herein by reference.

### BACKGROUND OF THE INVENTION

### 1. Field of the Invention

The present invention generally relates to a technique for searching for a path.

### 2. Description of the Related Art

Higher need for improvement in operation efficiency has led to a demand for a technique for improving the efficiency of operations in warehouses, factories, and the like (hereinafter, “warehouses and the like”) that are carried out using a plurality of autonomous bodies. An optimization technology for optimizing operation-related information (order patterns, layout, product arrangement, etc.) related to operations by a plurality of autonomous bodies has been widely researched and developed. In actual work in a warehouse or the like, however, a static situation where all day-operation details are known in advance rarely arises, and dynamic operations during which new tasks are added to a work schedule on a necessary basis are required. This creates a need for a high-speed searching technique that allows dynamic optimization.

In recent years, a technique for dynamically acquiring related traffic information and dynamically optimizing paths has been disclosed (see JP 2002-536648 W). The technique described in JP 2002-536648 W includes a mechanism with a potential relay function that re-transmits received data. According to the technique described in JP 2002-536648 W, such indexes as an average speed, a maximum speed, and a congestion sensitivity are calculated and shared to construct a system that after grasping a traffic situation, dynamically plans an optimum path.

### SUMMARY OF THE INVENTION

Conventionally, every time a task is added, the task is assigned to a free autonomous body and therefore a path is planned every time task addition arises. The resulting operation order, however, is not always an optimum operation order, which leads to a drop in overall operation efficiency. Searching for an operation order at every task addition, on the other hand, invites a problem of a significant increase in a calculation time. According to the technique described in JP 2002-536648 W, paths are dynamically optimized using information on the autonomous body itself and information on the surrounding environment. However, J P 2002-536648 W does not disclose a mechanism by which searching is speeded up by calculating a better path in advance for a plurality of via-points corresponding to the operation order.

The present invention has been conceived in view of the above problems, and it is therefore an object of the invention to propose a design execution apparatus or the like that can speed up searching for a path.

In order to solve such problems, a design execution apparatus according to the present invention includes: an input unit that inputs task group information indicating a task group including one or more tasks to be executed by an autonomous body and environmental information indicating an environment in which the task is executed; a determining unit that determines an order in which the autonomous body executes tasks included in a task group indicated by the task group information, based on the task group information and the environmental information that are input by the input unit; and a memory unit that stores order information indicating the order determined by the determining unit.

In the above configuration, for example, the order information indicating the order of passing through a plurality of via-points, the order being calculated in advance, can be used for a different task group. Every time a task group is added, therefore, the calculated order information is used for the added task group to be able to speed up searching for a path through which the autonomous body travels. According to the above configuration, for example, efficient task assignment using past calculation results can be implemented.

According to the present invention, a design execution apparatus that can speed up searching for a path is provided. Problems, configurations, and effects that are not mentioned above will be made clear by the following description of embodiments.

### BRIEF DESCRIPTION OF THE DRAWINGS

FIG. 1 depicts an example of a configuration of a design execution apparatus according to a first embodiment;

FIG. 2 depicts a specific example of is a task list according to the first embodiment;

FIG. 3 depicts a specific example of warehouse information according to the first embodiment;

FIG. 4 depicts an example of an overview of a host system of the design execution apparatus according to the first embodiment;

FIG. 5 depicts a specific example of operating information on an autonomous body according to the first embodiment;

FIG. 6 depicts a specific example of dynamic optimization according to the first embodiment;

FIG. 7 depicts a specific example of a go-around order optimization unit according to the first embodiment;

FIG. 8 depicts a specific example of the go-around order optimization unit according to the first embodiment;

FIG. 9 depicts a specific example of a path finding unit according to the first embodiment;

FIG. 10 depicts a specific example of an optimum environment finding unit according to the first embodiment;

FIG. 11 depicts a specific example of a UI screen according to the first embodiment; and

FIG. 12 depicts a specific example of input/output and of use of input/output in transfer operations, according to the first embodiment.

### DESCRIPTION OF THE PREFERRED EMBODIMENTS

### (I) First Embodiment

An embodiment of the present invention will hereinafter be described in detail. It should be noted, however, that the present invention is not limited to the embodiment.

This embodiment relates to a system that optimizes simultaneous operations carried out by a plurality of autonomous bodies in a warehouse or the like to execute designing with high applicability to worksite (e.g., to set an operation plan). Hereinafter, a set of tasks that are operations (processes) to be executed by an autonomous body will be referred to as a task group. A list in which task groups are arranged in an execution order is referred to as a task list. The autonomous body generally refers to an automated guided vehicle (AGV) that executes a task while traveling in a worksite, such as a warehouse, to an autonomous mobile robot, and to an on-site operator.

The design execution apparatus of this embodiment includes, for example, an input unit that inputs a task list and warehouse information indicating a state of a warehouse or the like, a determining unit that determines (searches for) an order in which tasks are executed in a task group, and a memory unit that stores an order found. According to the above configuration, efficient task assignment using past calculation results can be implemented.

The order in which the tasks in the task group are executed is the order in which the autonomous body travels through locations (points) at which the tasks are executed, indicating, for example, the order of autonomous body's going around (go-around order). Going around means the autonomous body's action that it departs from a first location (i.e., a standby point), executes the tasks included in the task group in order, and arrives at a second location (the same standby point, a different standby point, an unloading point, etc.). The first location and the second location may be the same or be different from each other.

The design execution apparatus may include a searching unit that searches for an optimum path, based on the go-around order, for the autonomous body that executes a task. The design execution apparatus, when dynamically assigning tasks, can give an instruct to execute an efficient operation plan including not only optimization of paths but also optimization of the go-around order of tasks. The searching unit may change parameters for an environment in which tasks are executed and search for an optimum path, based on the changed parameters for the environment.

When a task group is dynamically changed, the design execution apparatus may determine the go-around order of the task group, based on a saved go-around order.

The design execution apparatus may include at least one of an output unit that outputs a calculation result and a management unit that manages an operation status.

The design execution apparatus may change an order (execution order) in which a plurality of task groups are assigned to autonomous bodies and may search for an optimum path through which each of the autonomous bodies travels, based on the changed execution order.

In this specification, such notations as “first”, “second”, and “third” are appended to constituent elements to identify them, and do not necessarily limit the number or order thereof. In addition, numbers for identifying constituent elements are used on a context-by-context basis and therefore a number used for a constituent element in one context does not necessarily indicate the same constituent element in another context. Furthermore, a case where a constituent element identified by a certain number functions also as a constituent element identified by a different number is not excluded.

Embodiments of the present invention will then be described with reference to the drawings. The following description and drawings are exemplary one for explaining the present invention, and are omitted and simplified, when necessary, for clear explanations. The present invention may also be implemented in various forms other than the embodiments described herein. Unless otherwise specified, each constituent element of a single form and that of a plural form are both applicable.

In the following description, the same constituent elements will be denoted by the same reference numerals in the drawings and description of the same constituent elements will be omitted when necessary.

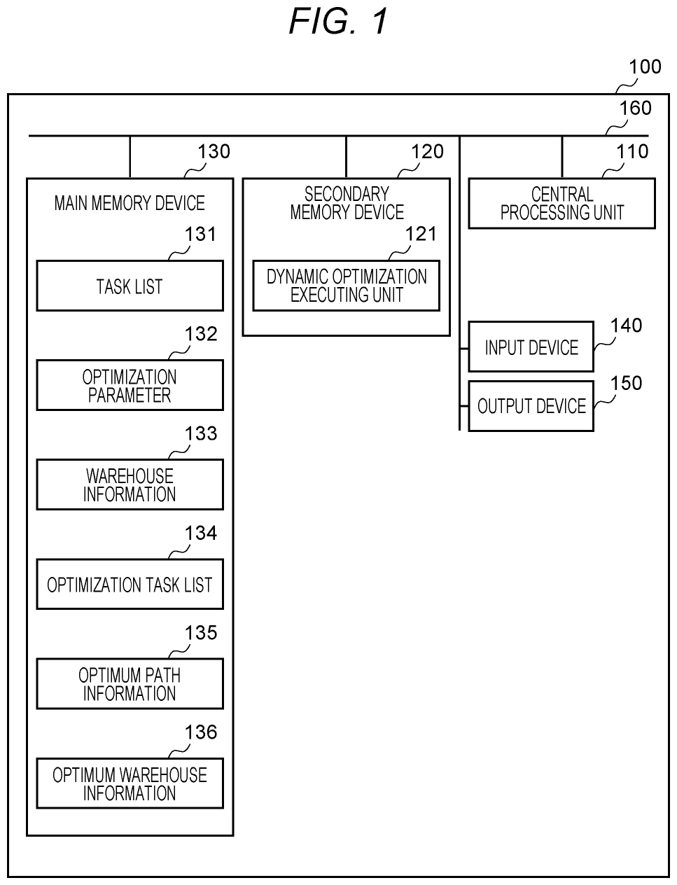

In FIG. 1, 100 denotes a design execution apparatus according to the first embodiment as a whole.

FIG. 1 depicts an example of a hardware configuration of the design execution apparatus 100.

The design execution apparatus 100 includes one or more computers. The design execution apparatus 100 includes, for example, a central processing unit 110, a secondary memory device 120, a main memory device 130, an input device 140, and an output device 150. The central processing unit 110, the secondary memory device 120, the main memory device 130, the input device 140, and the output device 150 are connected to each other via a bus 160.

The central processing unit 110 is a processor that executes programs stored in the secondary memory device 120 or the main memory device 130. The secondary memory device 120 is, for example, a nonvolatile memory device with a large capacity, such as a magnetic memory device or a flash memory, and stores a dynamic optimization executing unit 121 that is a program for executing optimization. The dynamic optimization executing unit 121 may be stored in the main memory device 130.

The main memory device 130 is, for example, a volatile memory device allowing high-speed access, such as a dynamic random access memory (DRAM), and stores an operating system (OS) and an application program. The central processing unit 110 executes the operating system to implement basic functions of the computer, and executes an application program to implement a function the computer offers.

More specifically, the main memory device 130 stores various pieces of information, such as a task list 131, an optimization parameter 132, warehouse information 133, an optimum task list 134, optimum path information 135, and optimum warehouse information 136. These various pieces of information may be stored in the secondary memory device 120 or may be stored in a different memory device that can communicate with the design execution apparatus 100.

The input device 140 is a user interface, such as a keyboard and a mouse. The output device 150 is a user interface, such as a display device and a printer.

The design execution apparatus 100 may include a communication device (communication interface) that is connected to a network to control communication with other terminals. In this case, the design execution apparatus 100 may be connected to a terminal via the communication interface and the terminal may has the input device 140 and the output device 150. For example, the design execution apparatus 100 processes data on a table in accordance with a request from the terminal, and outputs process results to the terminal.

The design execution apparatus 100 may be physically constructed on one computer or may be physically constructed on a logical block configured on one or multiple computers.

Additionally speaking, a function (the dynamic optimization executing unit 121, etc.) of the design execution apparatus 100 may be implemented by, for example, a process of the central processing unit 110 loading a program from the secondary memory device 120 onto the main memory device 130 and executing the program (software), or by hardware, such as a dedicated circuit, or by a combination of software and hardware. One function of the design execution apparatus 100 may be divided into a plurality of functions or a plurality of functions may be integrated into one function. Some of the functions of the design execution apparatus 100 may be provided as other separate functions or may be included in different functions. Some of the functions of the design execution apparatus 100 may be implemented by a different computer capable of communicating with the design execution apparatus 100.

The dynamic optimization executing unit 121 will then be described. The dynamic optimization executing unit 121 receives input of the task list 131, the optimization parameter 132, and the warehouse information 133 and outputs the optimum task list 134 and the optimum path information 135. By using the dynamic optimization executing unit 121, for example, an on-site operator is able to acquire order information and path information that maximize the operation efficiency of the autonomous body.

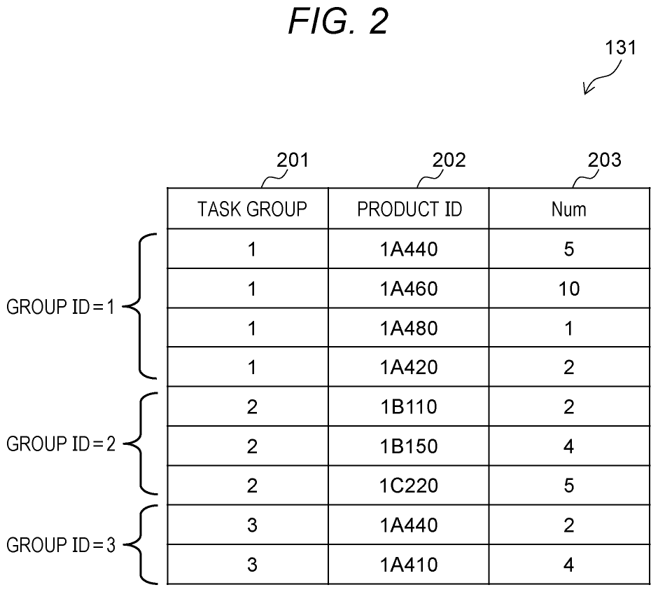

FIG. 2 depicts a specific example of the task list 131 in FIG. 1.

The task list 131 is, for example, a table in which tasks (operations) to be executed by each autonomous body, such as picking, are listed in an execution order. The autonomous body, such as the on-site operator or a robot, is assigned a task group to be executed by the autonomous body, the task group being selected from the task list 131, and executes tasks according to an instruction.

The task list 131 is a table of data in which parameters are stored in columns as parameter values are stored in rows. The columns include a Task Group 201 column, a product ID 202 column, and a Num 203 column. For example, an instruction to take a product out of a given shelf in a warehouse is expressed by entries in one row of the task list 131. This one row is referred to as a task, and a set of tasks that the same autonomous body needs to collectively execute while going around is referred to as a task group. Task groups arranged in an execution order makes up the task list 131.

Additionally speaking, tasks refer to operations the autonomous body carries out while traveling around in a given space, and include a task of which the operation efficiency changes when the order of the autonomous body's operations involving its transfer is changed. Tasks include a task of taking out articles, such as commodities, products, and parts, in a warehouse, a task of putting articles delivered to the warehouse in a shelf, and a task of confirming what is located where (inspecting articles). A task may be an operation carried out between different warehouses. In this embodiment, the task will be described mainly as an operation of taking out a product in the warehouse.

Task Group 201 indicates a unique ID of a task group, and tasks (rows) with the same value in Task Group 201 are collectively executed by the same autonomous body. Product ID 202 indicates the name or ID of a product to be taken out. By referring to a product arrangement table 320, which will be described later, in the warehouse information 133, the autonomous body is able to acquire coordinate information on a location where a product is stored. Num 203 indicates information on the number of products to be taken out. In addition, a column for specifying autonomous bodies individually in charge of different orders or IDs of such autonomous bodies may also be included in the task list 131, in which necessary columns could be changed depending on an operation form in the warehouse, the size of products handled, etc.

In this manner, the on-site operator or the robot executes an in-warehouse task of taking products out of shelves according to a list equal in format to the task list 131. Information included in the task list does not necessarily need to be handled in a table format, and may be handled, for example, in such a way that the information is written in a text form and is stored in a memory.

The specific example of the task list 131 shown in FIG. 2 lists four tasks with a value in Task Group 201 being “1”. When the task list 131 is input in execution of an actual operation, the optimum task list 134 in which the order of tasks is optimized is output. The optimum task list 134 is a list equal in format to the task list 131, and tasks listed in the optimum task list 134 are assigned to the autonomous body in descending order with a task ranked higher being assigned first. For example, in a case where the optimum task list 134 is identical with the task list 131, tasks of task groups with a value in Task Group 201 being “1” are assigned in order to the autonomous body. The autonomous body executes the tasks of the assigned task groups in descending order, that is, picks products identified by values “1A440”, “1A460”, “1A480”, and “1A420” in product ID 202 in descending order, and transfers the picked products to an unloading place. When finishing with the picking operation for the assigned task groups, the autonomous body becomes a free state, and is assigned a next task group. In an actual operation, a plurality of such autonomous bodies carry out their picking operations simultaneously.

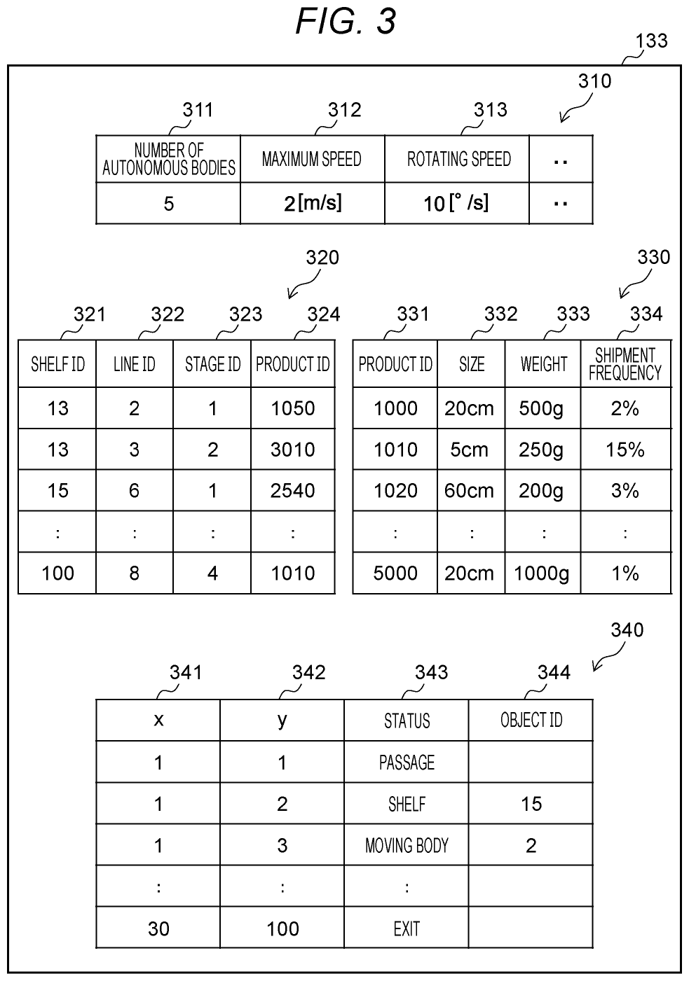

FIG. 3 depicts a specific example of the warehouse information 133 in FIG. 1.

The warehouse information 133 is a generic term for parameters that determine the operation environment of the warehouse, the operation environment being optimized, in detail.

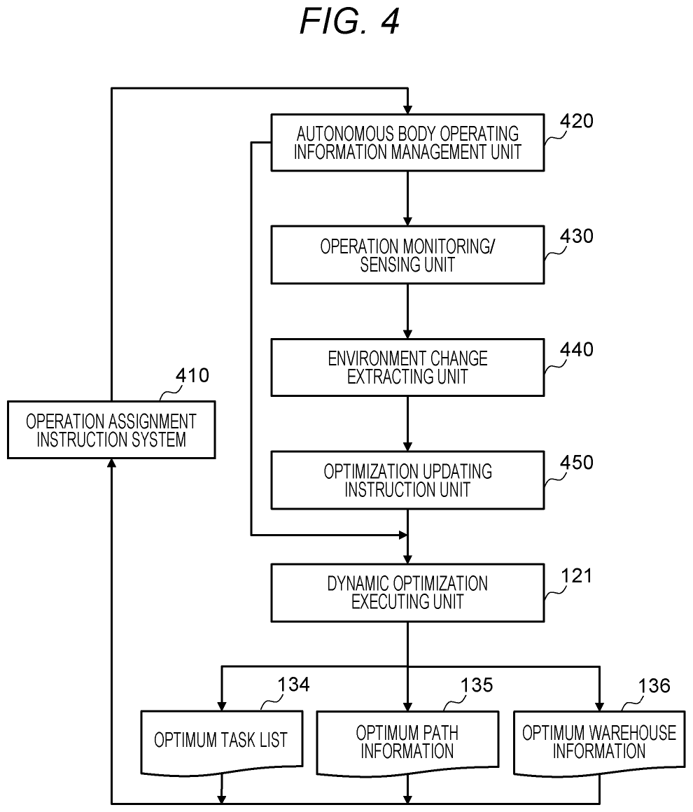

An autonomous body operating history table 310 is a table that stores information on an operation history of the autonomous body. This information is extracted from an operation assignment instruction system 410 shown in FIG. 4, by the autonomous body operating information management unit 420. As an example of the information stored in the autonomous body operating history table 310, parameters related to the performance, properties, etc., of the autonomous body, such as number of autonomous bodies 311, maximum speed 312, and rotation speed 313, are stored in the autonomous body operating history table 310.

The product arrangement table 320 is a table that uniquely determines arrangement of products in the warehouse. In the product arrangement table 320, the location of a product is specified by shelf ID 321, line ID 322, and stage ID 323, and an ID of the product is specified by product ID 324.

A product master table 330 is a table that stores property information on all products stored in the warehouse. The product master table 330 stores, for example, size 332, weight 333, and shipment frequency 334 for each value in product ID 331, as property information.

A warehouse layout table 340 is a table that defines a layout, such as a shelf layout in the warehouse. In the warehouse layout table 340, for example, coordinates are determined by values in x 341 and y 342, property, such as a passage, a shelf, a moving body, and an exit, is determined by a value in status 343, and an ID of an object is determined by a value in object ID 344.

When the task list 131, the warehouse information 133, etc., to be optimized are determined, objective function values to be maximized, which include throughput of the warehouse, are uniquely determined through simulations or actual operations.

FIG. 4 depicts an example of an overview of a host system (operation management system) of the design execution apparatus 100.

The operation assignment instruction system 410 is a system that gives assignment (task assignment and path assignment) of and an instruction on operations carried out in the warehouse to which the design execution apparatus 100 of this embodiment is introduced. The operation assignment instruction system 410 manages day-operation details and determines the details of operations of the on-site operator and each robot.

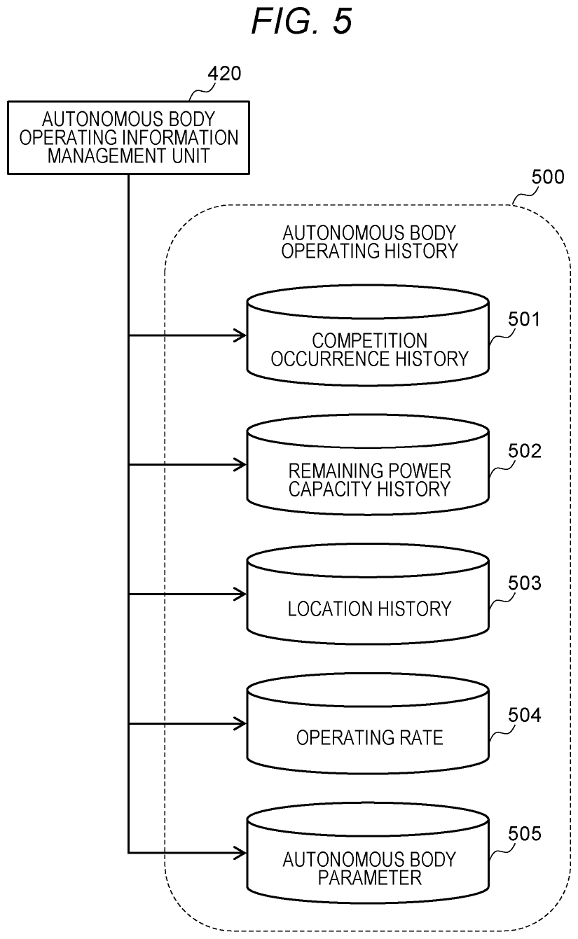

The autonomous body operating information management unit 420 extracts information stored in the autonomous body operating history table 310 of the warehouse information 133, from the operation assignment instruction system 410, and manages the extracted information. This process will be described in detail with reference to FIG. 5. An operation monitoring/sensing unit 430 monitors an overall operation status of the warehouse, the operation status being acquired as operation status information collected from the operation assignment instruction system 410, the autonomous body operating history table 310, and sensors installed on the worksite, and the like. An environment change extracting unit 440 extracts a change in an operation environment, based on the operation status information collected by the operation monitoring/sensing unit 430. An optimization updating instruction unit 450 determines whether it is necessary to update the current operation environment, based on environment change information extracted by the environment change extracting unit 440.

Based on an optimization updating instruction from the optimization updating instruction unit 450 and operating information on the autonomous body acquired from the autonomous body operating information management unit 420, the dynamic optimization executing unit 121 calculates and outputs the optimum task list 134, the optimum path information 135, and the optimum warehouse information 136 so that operation assignment and path assignment following an optimum go-around order are given to the autonomous body in operation.

FIG. 4 shows an example of a system configuration according to the present embodiment for a case where the existence of an operation management system for the warehouse is assumed. In a system requiring dynamic optimization in which the dynamic optimization executing unit 121, which plays a central role in this embodiment, adds tasks when necessary, operation assignment and path assignment following the optimum go-around order can be carried out simultaneously.

FIG. 5 depicts a specific example of operating information on the autonomous body managed by the autonomous body operating information management unit 420.

Information managed by the autonomous body operating information management unit 420 is referred to as an autonomous body operating history 500. Specifically, a competition occurrence history 501 include the number of times of competitions occurred, a competition occurrence rate per travel distance, and the location of occurrence of competition. A remaining power capacity history 502 include a remaining power capacity average and a remaining power capacity change rate. A location history 503 include location coordinates at each time and a congestion rate, of each autonomous body. An operating rate 504 include a total traveling time, a standby time, an operating ratio, i.e., a ratio between a standby time and an operating time, an average speed, and speed variance, of each autonomous body. An autonomous body parameter 505 include the number of autonomous bodies, the size of each autonomous body, a payload size, a maximum speed, and a power capacity.

The autonomous body operating information management unit 420 extracts these pieces of information from the operation assignment instruction system 410, which is the host system, and manages the extracted information, and inputs the information to the dynamic optimization executing unit 121. These pieces of information are used in any of these cases where a heuristic method, such as A * (Aster), a learning method using machine learning or reinforcement learning, and a searching-based optimization method, such as GA (genetic algorithm), are employed as dynamic optimization methods. Combining together the autonomous body operating history 500 and a searching-based optimization method allows simultaneously estimating a degree of congestion and the number of autonomous bodies that can travel, thus improving the accuracy of optimization.

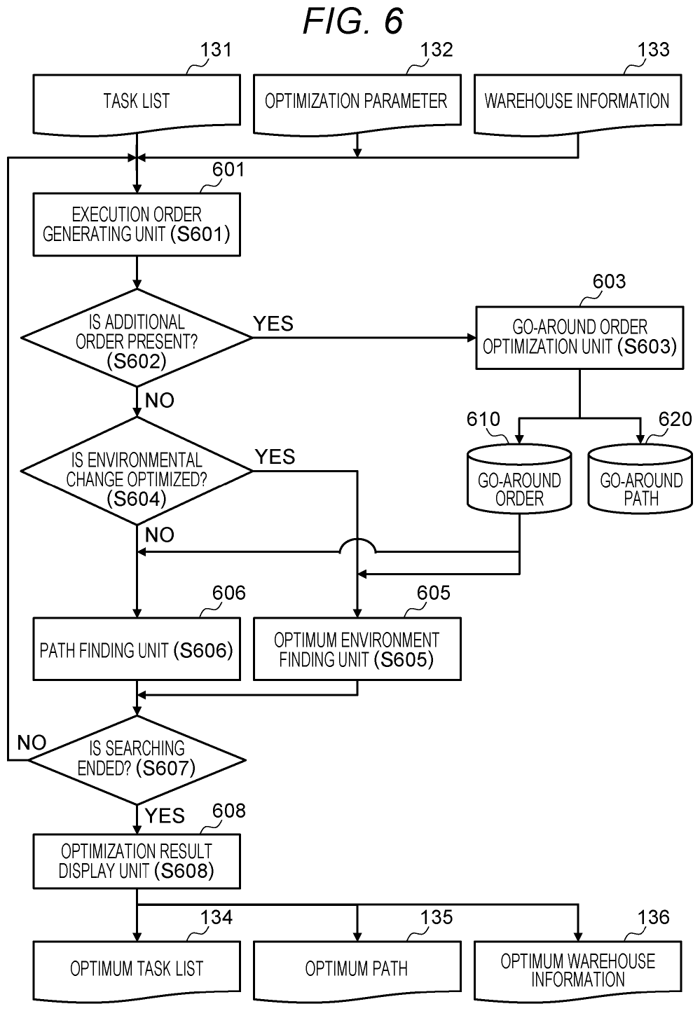

FIG. 6 depicts a specific example of dynamic optimization by the dynamic optimization executing unit 121.

The dynamic optimization executing unit 121 receives input of the task list 131, the optimization parameter 132, and the warehouse information 133 and outputs the optimum task list 134, the optimum path information 135, and the like. The optimization parameter 132 is a parameter used for searching for a path and includes a condition for ending the searching for a path. The warehouse information 133 indicates the entire information on the operation environment of the warehouse, such as the autonomous body operating history 500 output from the autonomous body operating information management unit 420 shown in FIG. 5, the layout of the warehouse, and the product arrangement.

In S601, the dynamic optimization executing unit 121 (execution order generating unit 601) generates candidates for execution orders (order patterns) between the task groups.

In S602, the dynamic optimization executing unit 121 determines whether the input task list 131 has a difference with a task list 131 input in the past (for example, whether an additional order is present). For example, the dynamic optimization executing unit 121 holds task lists 131 input in the past, and compares the previously input task list 131 with the currently input task list 131. When the input task lists 131 have no difference, the process flows proceeds to S604. When the input task lists 131 have a difference, the process flows proceeds to S603.

In S603, the dynamic optimization executing unit 121 (the go-around order optimization unit 603) calculates a go-around path for a task group for which a go-around path and a go-around order are not found yet, the task group being among task groups stored in the task list 131, and executes searching for a go-around order. Optimum go-around order information and optimum go-around path information obtained by the searching in S603 are stored in the go-around order 610 and the go-around path 620. The go-around order 610 and the go-around path 620 hold these pieces of information while an operation by dynamic optimization continues and discards them when an operation schedule is over, e.g., the day-operation is completed.

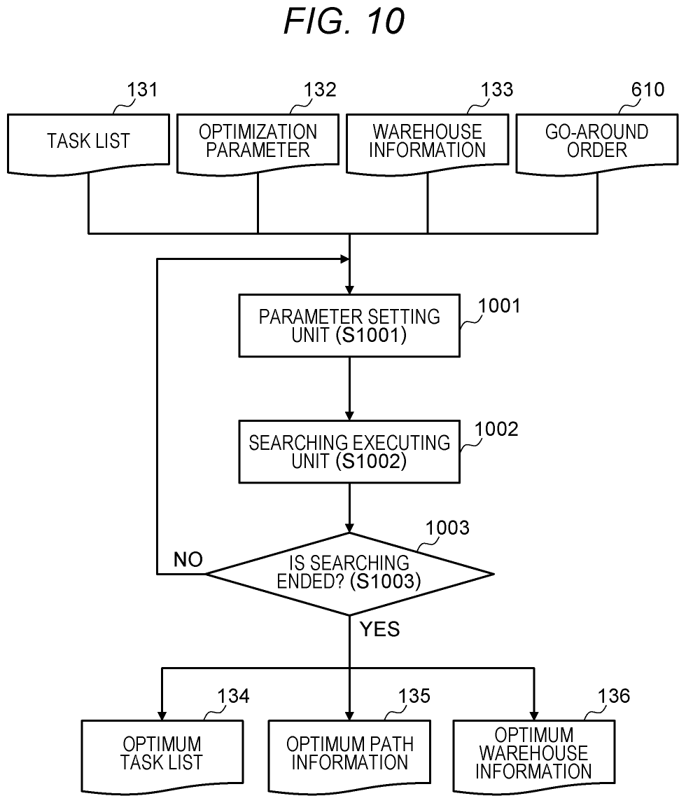

In S604, the dynamic optimization executing unit 121 makes a decision to use a function of operation optimization and a function of dynamic operation optimization as separate functions. For example, the dynamic optimization executing unit 121 determines whether or not to optimize an environmental change (e.g., whether a button “searching again” has been pressed on a screen 1100, which will be described later). When YES results in S604 (operation optimization), the process flow proceeds to S605. When NO results in S604 (dynamic operation optimization), the process flow proceeds to S606. S605 will be described later with reference to FIG. 10.

In S606, the dynamic optimization executing unit 121 (path finding unit 606) searches for a path that prevents competition for path when a plurality of autonomous bodies having been assigned task groups execute tasks simultaneously. The path finding unit 606 receives go-around order information on a go-around order found, from the go-around order 610, and searches for a path that avoids competition for path by the autonomous bodies executing operations simultaneously. Methods to employ for the searching include a multi-agent path finding (MAPF) method, such as a hierarchical cooperative a* (HCA) and a conflict-based search (CBS).

In S607, the dynamic optimization executing unit 121 determines whether or not to end the searching. When YES results in S607, the process flow proceeds to S608. When NO results in S607, the process flow proceeds to S601. When an order pattern with a best evaluation value (order pattern with the smallest distance when distance is the evaluation value) among order patterns having been found so far is equal to or smaller than a threshold, the dynamic optimization executing unit 121 outputs the order pattern (solution) with the best evaluation value, but when this order pattern exceeds the set threshold, selects an order pattern with a best evaluation value out of order patterns found in the past and outputs the selected order pattern, and then ends the searching. When the searching condition is not met in S607, the process flow returns to S601, at which the dynamic optimization executing unit 121 generates a different order pattern and repeats evaluations. As a result, an execution order with a better evaluation value can be calculated for the task list 131.

In S608, the dynamic optimization executing unit 121 (optimization result display unit 608) outputs information on a path found by the path finding unit 606 or the optimum environment finding unit 605, in a visual form. Finally, the optimum task list 134 in which task groups are rearranged according to an execution order and go-around order with improved operation efficiency and the optimum path information 135 that prevents competition for path are output. In a case where step S605 is executed, the optimum warehouse information 136 is output as well.

What is done by the dynamic optimization executing unit 121 is as follows. When the task list 131 is input, the go-around order optimization unit 603 calculates and saves a separate optimum go-around order for each task group. Because of this, when a new task list 131 is input, optimum go-around order information on an existing task group can be extracted from the go-around order 610 and used for the new task list 131. Hence the whole searching process is speeded up. Through this improvement, in a dynamic optimization case that requires faster optimization, order optimization and path optimization can be executed simultaneously.

The autonomous body, which is actually operated based on an operation plan (the optimum task list 134, the optimum path information 135) determined in the above manner, executes picking in an optimized order different from a picking order (go-around order and/or execution order) indicated in the input task list 131. When a task in the same task group is added, go-around order information found in the past is used for the task. The autonomous body thus executes picking while going around in a go-around order equal to a go-around order executed in the past. While past searching results are used for the go-around order, however, a path not conflicting with a path for another autonomous body concurrently picking a product is newly planned in an actual operation. A path itself, on which the autonomous body travels, therefore changes.

As described above, by separately executing optimization of the go-around order and/or the execution order and optimization of the path for avoiding competition for path, cost required for order optimization can be reduced and order optimization and path optimization can be simultaneously achieved in execution of dynamic optimization.

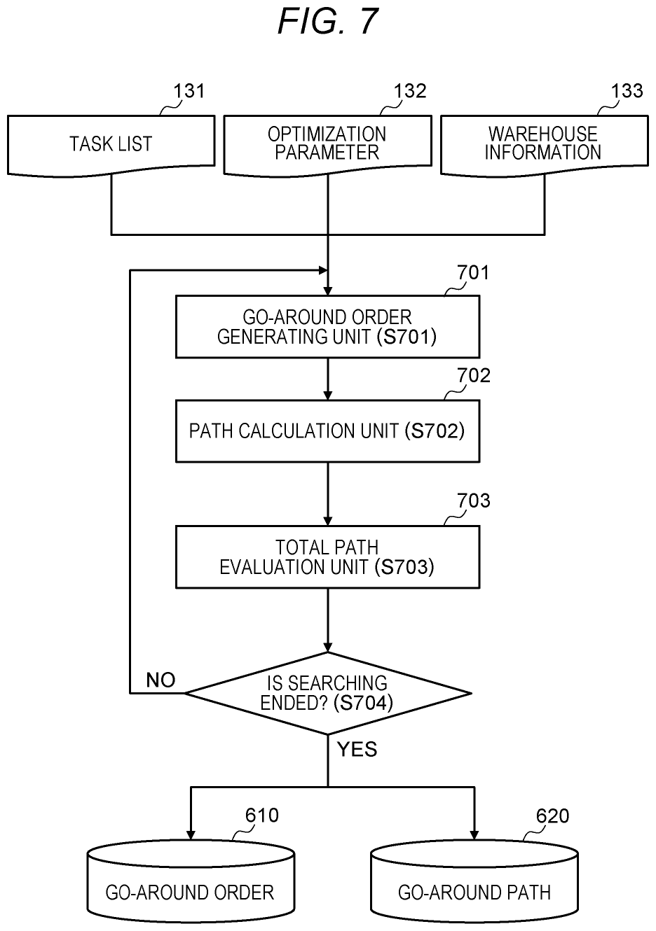

FIG. 7 depicts a specific example of the go-around order optimization unit 603.

The go-around order optimization unit 603 receives input of the task list 131, the optimization parameter 132, and the warehouse information 133, and outputs the go-around order 610 and the go-around path 620.

In S701, a go-around order generating unit 701 generates a candidate for the order of execution of tasks (order pattern) for a target task group in the task list 131 subjected to searching.

In S702, a path calculation unit 702 searches for a path that would be taken when each task is executed based on an order pattern generated by the go-around order generating unit 701. For searching for the path, various methods may be adopted, the methods being executed to find the path by using a heuristic method, such as A*, machine learning, reinforcement learning, rule base, and the like.

In S703, a total path evaluation unit 703 adds up paths for individual tasks, thereby calculating a total distance required to execute the tasks of the target task group, as an evaluation value. Examples of the evaluation value calculated by the total path evaluation unit 703 include a Euclidean distance, a Manhattan distance, and a weighted distance weighted according to a traveling direction, a degree of congestion, etc., which are defined by various evaluation methods.

In S704, when an order pattern with a best evaluation value (order pattern with the smallest distance when distance is the evaluation value) among order patterns having been found so far is equal to or smaller than a threshold, the total path evaluation unit 703 outputs the order pattern (solution) with the best evaluation value, but when this order pattern exceeds the set threshold, selects an order pattern (solution) with a best evaluation value out of order patterns found in the past and outputs the selected order pattern, and then ends the searching. When the searching condition is not met in S704, the process flow returns to S701, at which a different order pattern is generated and evaluations are repeated. As a result, a go-around order with a better evaluation value can be calculated for the tasks of the target task group.

In addition, results of calculation of go-around orders and go-around paths are saved by the go-around order 610 and the go-around path 620, and for the same task group or a task group including the same tasks, the saved calculation results are used. As a result, an optimum go-around order information can be acquired without repetitive calculations by the go-around order optimization unit 603. Additionally speaking, a task group including the same tasks (partially matching task group) can be used as an initial value for order pattern generation in S701.

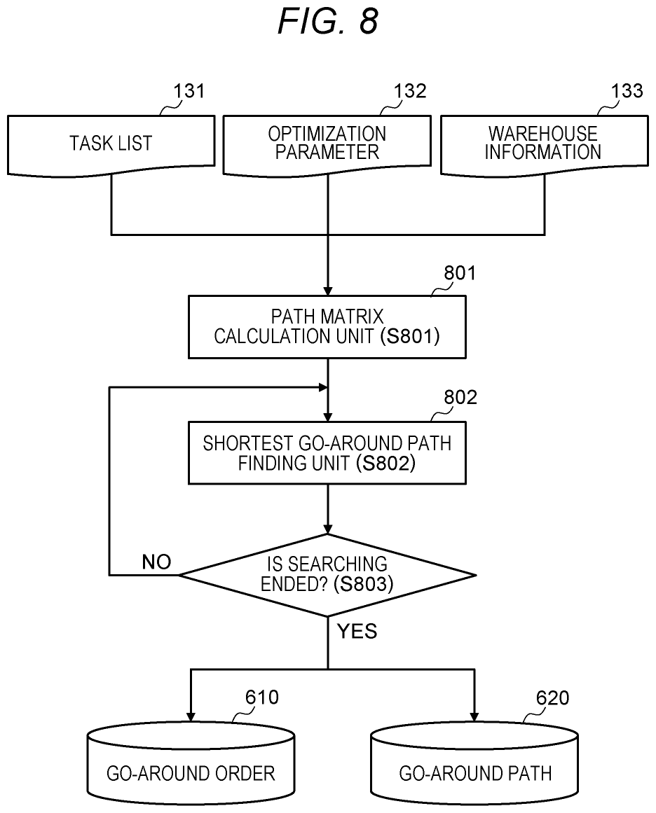

FIG. 8 depicts a specific example of another form of the go-around order optimization unit 603 that executes different processes.

The go-around order optimization unit 603 (another form) shown in FIG. 8 has the same inputs and outputs as the go-around order optimization unit 603 shown in FIG. 7 does, and calculates the go-around order 610 and the go-around path 620 by a path matrix calculation unit 801 and a shortest go-around path finding unit 802.

In S801, the path matrix calculation unit 801 calculates all paths for tasks in a target task group in the task list 131, and maps evaluation value (distance) information into a matrix (path matrix). To calculate the paths, such methods as A*, rule base, machine learning, and reinforcement learning can be used.

In S802, based on the path matrix calculated by the path matrix calculation unit 801, the shortest go-around path finding unit 802 searches for an order in which visit destinations related to all tasks are drawn in one stroke in a shortest path. Such a problem is generally referred to as a traveling salesman problem (TSP), and various algorithms and methods are proposed as a solution to the problem. A proper algorithm, therefore, can be selected as calculation resources and the scale of the problem are taken into consideration.

In S803, when an obtained solution satisfies a set threshold or exceeds a set searching time, the shortest go-around path finding unit 802 ends the searching, and at that point of time, outputs a solution with a best evaluation value, as the go-around order 610 and the go-around path 620.

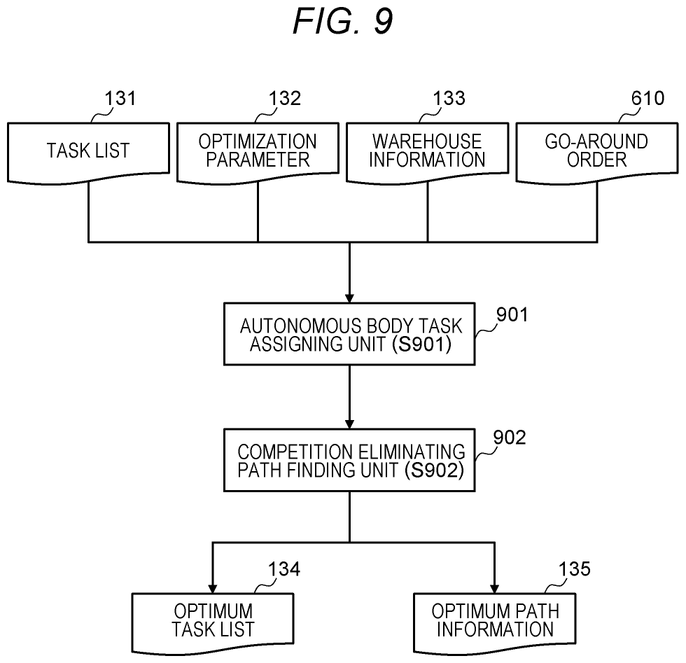

FIG. 9 depicts a specific example of the path finding unit 606.

Receiving input of the task list 131, the optimization parameter 132, and the warehouse information 133 plus the go-around order 610 calculated by the go-around order optimization unit 603 and saved, the path finding unit 606 searches for a path so that competition for path does not occur when a plurality of autonomous bodies simultaneously execute their tasks, and outputs the optimum task list 134 and the optimum path information 135.

In S901, an autonomous body task assignment unit 901 assigns a task group to an autonomous body in a free state, the autonomous body being one of a plurality of autonomous bodies in operation and currently not assigned any task group, such that a task group not assigned to any autonomous body yet among task groups in the task list 131 is assigned according to an order in which the task groups are listed.

In S902, for each of autonomous bodies having been assigned task groups, a competition eliminating path finding unit 902 searches for a path for executing a task in a go-around order stored in the go-around order 610. At this time, the competition eliminating path finding unit 902 searches for a path that prevents the autonomous bodies from competing with each other for path and that is the shortest path. An optimum path that avoids autonomous bodies' competing for path can be found by using an MAPF method including HCA and CBS, or a task allocation and path finding (TAPF) method by which MAPF solutions are extended and applied to a continuous work assignment problem. Path information finally calculated is output as the optimum task list 134 and the optimum path information 135.

The path finding unit 606 shown in FIG. 9 is a module that is assumed to be applied to an online operation in which tasks are added when necessary during operations in the warehouse and task assignment to the autonomous body and path optimization for the autonomous body are carried out on a necessary basis. The optimum environment finding unit 605 shown in FIG. 10, on the other hand, is a module that is assumed to be applied to an analytical optimization case where when the operation environment of the warehouse is changed variously, an operation environment with the best evaluation value is searched for.

FIG. 10 depicts a specific example of the optimum environment finding unit 605.

The optimum environment finding unit 605 receives input of the task list 131, the optimization parameter 132, the warehouse information 133, and the go-around order 610, and outputs the optimum task list 134, the optimum path information 135, and the optimum warehouse information 136.

In S1001, a parameter setting unit 1001 changes a value (parameter) in the warehouse information 133 and sets a different parameter for searching. Examples of this step include, for example, increasing the number of autonomous bodies by one, and changing the warehouse layout.

In S1002, a searching executing unit 1002 executes optimization, based on the parameter set by the parameter setting unit 1001, and calculates an evaluation value.

In S1003, when a best evaluation value among evaluation values for orders having been found so far is equal to or smaller than a threshold, the searching executing unit 1002 outputs a solution with the best evaluation value, but this evaluation value exceeds the set threshold, selects a solution with a best evaluation value out of evaluation values found in the past and outputs the selected solution, and then ends the searching. Specific methods of this searching-based optimization include a searching-based algorithm, such as GA or RL (Reinforcement Learning), and a learning method. Finally, simulations and evaluations are carried out on different pieces of warehouse information 133, and the optimum task list 134, the optimum path information 135, and the optimum warehouse information 136 are output.

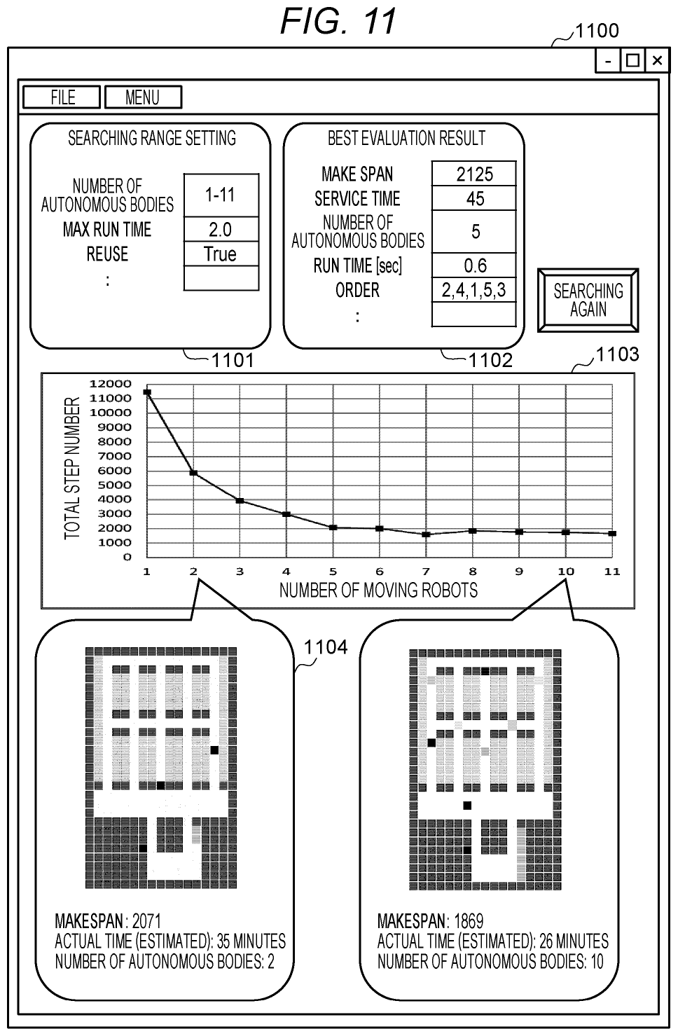

FIG. 11 depicts a specific example of a UI screen (screen 1100) on which the optimization result display unit 608 outputs input information and searching results at execution of dynamic optimization.

Searching range setting 1101 allows operation environment setting and a simulation of an evaluation value, such as productivity in different operation environments. Specific examples of parameters set in the searching range setting 1101 include the number of autonomous bodies and a maximum calculation time. Best evaluation result 1102 displays various evaluation values under an operation environment that are set in the searching range setting 1101. Displayed evaluation values include, for example, Makespan indicating operation completion times of all autonomous bodies end their operations, Service time indicating operating rate information, and a calculation time.

A graph 1103 is a specific example of visualization of changes in productivity under different operation environments. In this specific example, the horizontal axis represents the number of autonomous bodies (Number of Moving Robots), and the vertical axis represents Total Step Number (Makespan). By changing the number of autonomous bodies, completing the same list of tasks takes different costs (Makespan), which can be compared with each other. Path map 1104 is information that visualizes a path that each autonomous body actually follows when executing a task.

An on-site supervisor confirms such a screen 1100 concerning an obtained optimum operation plan, thus making a decision on a final operation plan. In this embodiment, searching is speeded up by using the saved go-around order information. This allows the supervisor to confirm a simulation result displayed on the path map 1104 and, during an operation in which autonomous bodies are actually used, to confirm a scene that an autonomous body having been assigned a task group including the same tasks travels through a path in the same go-around order.

When dynamic optimization is implemented, the implementation status of dynamic optimization can be known by checking the UI screen indicating an optimization status, as shown in FIG. 11. In addition, in an optimization scene where an efficient warehouse operation environment is determined through a trial-and-error process by changing the number of autonomous bodies, the warehouse layout, etc., using the optimum environment finding unit 605, the UI screen indicating parameter inputs and searching results, as shown in FIG. 11, is needed. Information indicating visualized results include path information determined by dynamic optimization. In a determined path, reuse of a go-around order found in the past, the reuse being made possible by this embodiment, can be confirmed. By using this embodiment, the on-site operator is able to know the optimum layout of the warehouse for using the warehouse efficiently and the optimum number of autonomous bodies.

To adopt a dynamic optimization method and dynamically deal with environmental changes in actual operations, a system that allows the on-site supervisor to understand a going-on event and a go-around order, a path, etc., adopted by dynamic optimization and monitor them for safety is needed. In addition, from the viewpoint of safety, confirmation and decision making by the on-site operator are essential, and for that end, the above UI screen and or a dashboard are necessary.

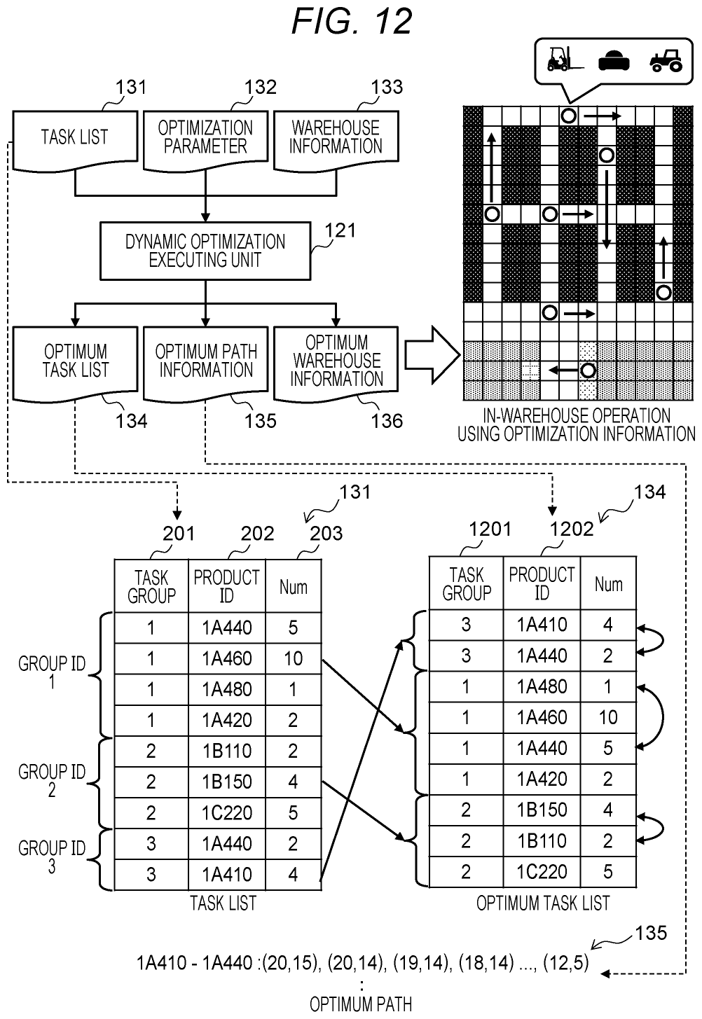

FIG. 12 depicts a specific example of inputs/outputs to/from the dynamic optimization executing unit 121 and a specific example of a situation where such optimization information is used in an actual transfer operation.

In FIG. 12, the dynamic optimization executing unit 121 receives input of the task list 131, the optimization parameter 132, and the warehouse information 133, and outputs the optimum task list 134, the optimum path information 135, and the optimum warehouse information 136.

An example of the task list 131 and the optimum task list 134, which are in table formats, is shown in the lower side of FIG. 12. The task list 131 and the optimum task list 134 are tables having the same columns and the same elements, and both lists indicate tasks to be executed in one day or some of those tasks. Optimization by the dynamic optimization executing unit 121 changes the order of execution of tasks and task groups in the task list 131, and consequently the optimum task list 134 is output, in which those tasks and task groups are rearranged in an optimized execution order. At the same time, paths indicating transfers between tasks are also optimized, and the optimum path information 135 is output.

The optimum path information 135 is information specifically expressing transfers between tasks, and an example of the optimum path information 135 is shown in the lower side of FIG. 12. The specific example of the optimum path information 135 indicates an optimum transfer from a task on product ID “1A410” to a task on product ID “1A440” included in Task Group 1201 being “3” in the optimum task list 134. Various methods of expressing a path may be adopted, which include a method of expressing the path as coordinates on a latticed simulation map, which is shown as the specific example, a method of expressing the path as coordinates on an actual layout diagram, and a method of expressing the path as a path connecting via-points.

The dynamic optimization executing unit 121 delivers the optimum task list 134 and the optimum path information 135 to the host system that actually runs the warehouse to reflect them in an actual operation. Autonomous bodies to be operated are equipment that executes a task while traveling, such as an automatic forklift, an AGV, and an autonomous mobile robot (AMR). An on-site operator may also be included in the category of autonomous bodies. By assigning a task (e.g., transfer operation) to the autonomous body according to the optimum task list 134 and the optimum path information 135, efficient warehouse operations can be achieved.

### (II) Note

The above embodiment includes, for example, the following descriptive contents.

In the above embodiment, the case where the present invention is applied to the design execution apparatus has been described. The present invention, however, is not limited in application to this case, and may also be applied widely to other various systems, apparatuses, methods, and programs.

In addition, in the above embodiment, some or all of programs may be installed from a program source into a device, such as a computer, that serves as the design execution apparatus. The program source may be, for example, a program distribution server connected via a network or a computer-readable recording medium (e.g., a non-transitory recording medium). In the above description, two or more programs may be implemented as one program or one program may be implemented as two or more programs.

In the above embodiment, the configuration of each table is shown exemplarily. One table may be divided into two or more tables, or the whole or a part of two or more tables may be one table.

In the above embodiment, for convenience of description, information related to the design execution apparatus has been described using tables. However, the data structure of the information is not limited to a table structure. The information related to the design execution apparatus may be expressed in a data structure different from the table structure, such as an extensible markup language (XML), a YAML Ain't a markup language (YAML), a hash table, or a tree structure.

In the above embodiment, the screen illustrated and described is an exemplary one, and may be designed into any form providing that information the screen receives is the same.

In the above embodiment, the screen illustrated and described is an exemplary one, and may be designed into any form providing that information the screen displays is the same.

In the above embodiment, output of information is not limited to display on the display device. Information may be output as a sound from a speaker, as a data file, as printout on a paper medium, etc., as a projection on a screen by a projector, or as information in other forms.

Information for implementing functions, such as programs, tables, and files, may be stored in a storage device, such as a memory, a hard disk, and a solid state drive (SSD), or in a recording medium, such as an IC card, an SD card, and a DVD.

The above embodiment has, for example, the following characteristic configurations.

(1)

A design execution apparatus (e.g., the design execution apparatus 100) includes: an input unit (the dynamic optimization executing unit 121, the input device 140, the communication device, a circuit, etc.) that inputs task group information (the task list 131, a set of tasks in the same task group 201, etc.) indicating a task group including one or more tasks to be executed by an autonomous body and environmental information (e.g., the warehouse information 133) indicating an environment in which the task is executed; a determining unit (the dynamic optimization executing unit 121, the go-around order optimization unit 603, a circuit, etc.) that determines an order (e.g., go-around order) in which the autonomous body executes tasks included in a task group indicated by the task group information, based on the task group information and the environmental information that are input by the input unit; and a memory unit (the dynamic optimization executing unit 121, the secondary memory device 120, the main memory device 130, a memory device capable of communication with the design execution apparatus 100, a circuit, etc.) that stores order information (e.g., go-around order 610) indicating the order determined by the determining unit.

In the above configuration, for example, the order information indicating the order of passing through a plurality of via-points, the order being calculated in advance, can be used for a different task group. Every time a task group is added, therefore, the calculated order information is used for the added task group to be able to speed up searching for a path through which the autonomous body travels. According to the above configuration, for example, efficient task assignment using past calculation results can be implemented.

(2)

The design execution apparatus includes a first searching unit (the dynamic optimization executing unit 121, the path finding unit 606, a circuit, etc.) that searches for a path through which an autonomous body travels. When pieces of task group information for which an order has been determined by the determining unit and environmental information including information indicating use of a plurality of autonomous bodies are input by the input unit, the first searching unit searches for a path through which each of the autonomous bodies travels, based on pieces of order information corresponding respectively to the pieces of task group information, the environmental information, and the pieces of task group information that are stored in the memory unit (see S606, FIG. 9, etc.).

According to the above configuration, for example, when a plurality of autonomous bodies having been assigned task groups execute tasks simultaneously, a path that prevents competition for path can be searched for.

(3)

The first searching unit changes an order in which a plurality of task groups indicated by the pieces of task group information are assigned respectively to the plurality of autonomous bodies, and searches for a path through which each of the autonomous bodies travels, using the changed order (see, e.g., S601).

According to the above configuration, for example, when an order in which task groups are assigned to autonomous bodies is changed variously, a path with a better evaluation value can be calculated.

(4)

The design execution apparatus includes an output unit (the dynamic optimization executing unit 121, the output device 150, the optimization result display unit 608, the communication device, a circuit, etc.) that outputs information on a path found by the first searching unit (the screen 1100, the best evaluation result 1102, the graph 1103, the path map 1104, the diagram showing an in-warehouse operation in FIG. 12, etc.).

According to the above configuration, for example, the on-site operator is able to know the operation status of dynamic optimization by confirming the UI screen indicating an optimization status in a case of a task group being added.

(5)

The design execution apparatus includes a second searching unit (the dynamic optimization executing unit 121, the optimum environment finding unit 605, a circuit, etc.) that searches for a path through which an autonomous body travels. When pieces of task group information for which an order has been determined by the determining unit and environmental information including information indicating use of a plurality of autonomous bodies are input by the input unit, the second searching unit changes a parameter of the environmental information and searches for a path through which each of the autonomous bodies travels, based on pieces of order information corresponding respectively to the changed parameter, the pieces of task group information, and the pieces of task group information that are stored in the memory unit (see S605, FIG. 10, etc.).

According to the above configuration, for example, when an operation environment for the autonomous body, the warehouse, or the like is changed variously, an operation environment with a better evaluation value can be searched for.

(6)

The second searching unit changes an order in which a plurality of task groups indicated by the pieces of task group information are assigned respectively to the plurality of autonomous bodies, and searches for a path through which each of the autonomous bodies travels, using the changed order (see, e.g., S601).

According to the above configuration, for example, an operation environment with a better evaluation value and a path with a better evaluation value can be calculated.

(7)

The design execution apparatus includes an output unit (the dynamic optimization executing unit 121, the output device 150, the optimization result display unit 608, the communication device, a circuit, etc.) that outputs information on a path found by the second searching unit (the screen 1100, the best evaluation result 1102, the graph 1103, the path map 1104, etc.).

According to the above configuration, for example, the on-site operator is able to determine an efficient operation environment through a trial-and-error process by confirming the UI screen indicating an optimization status in a case of an operation environment for the autonomous body, the warehouse, or the like being changed variously.

The above configurations may be changed, rearranged, combined, or omitted, when necessary, without departing from the substance of the present invention.

What is claimed is:

1. A design execution apparatus comprising:
an input unit that inputs task group information indicating a task group including one or more tasks to be executed by an autonomous body and environmental information indicating an environment in which the task is executed;
a determining unit that determines an order in which the autonomous body executes tasks included in a task group indicated by the task group information, based on the task group information and the environmental information that are input by the input unit; and
a memory unit that stores order information indicating the order determined by the determining unit.

2. The design execution apparatus according to claim 1, comprising a first searching unit that searches for a path through which an autonomous body travels,
wherein when pieces of task group information for which an order has been determined by the determining unit and environmental information including information indicating use of a plurality of autonomous bodies are input by the input unit, the first searching unit searches for a path through which each of the autonomous bodies travels, based on pieces of order information corresponding respectively to the pieces of task group information, the environmental information, and the pieces of task group information that are stored in the memory unit.

3. The design execution apparatus according to claim 2, wherein the first searching unit changes an order in which a plurality of task groups indicated by the pieces of task group information are assigned respectively to the plurality of autonomous bodies, and searches for a path through which each of the autonomous bodies travels, using the changed order.

4. The design execution apparatus according to claim 2, comprising an output unit that outputs information on a path found by the first searching unit.

5. The design execution apparatus according to claim 1, comprising a second searching unit that searches for a path through which an autonomous body travels,
wherein when pieces of task group information for which an order has been determined by the determining unit and environmental information including information indicating use of a plurality of autonomous bodies are input by the input unit, the second searching unit changes a parameter of the environmental information and searches for a path through which each of the autonomous bodies travels, based on pieces of order information corresponding respectively to the changed parameter, the pieces of task group information, and the pieces of task group information that are stored in the memory unit.

6. The design execution apparatus according to claim 5, wherein the second searching unit changes an order in which a plurality of task groups indicated by the pieces of task group information are assigned respectively to the plurality of autonomous bodies, and searches for a path through which each of the autonomous bodies travels, using the changed order.

7. The design execution apparatus according to claim 5, comprising an output unit that outputs information on a path found by the second searching unit.

8. A design execution method comprising:
causing an input unit to input task group information indicating a task group including one or more tasks to be executed by an autonomous body and environmental information indicating an environment in which the task is executed;
causing a determining unit to determine an order in which the autonomous body executes tasks included in a task group indicated by the task group information, based on the task group information and the environmental information that are input by the input unit; and
causing a memory unit to store order information indicating the order determined by the determining unit.
